(19) United States
(12) Patent Application Publication
(10) Pub. No.: US 2012/0082824 A1
(43) Pub. Date: Apr. 5, 2012

(54) Thermal Poly Rubber (TPR) Layered Toy

(76) Inventors: Bradley D. Pedersen, Mississauga (CA); Kyle Jeffs, Mississauga (CA)

(21) Appl. No.: 13/253,025

(22) Filed: Oct. 4, 2011

Related U.S. Application Data
(60) Provisional application No. 61/389,683, filed on Oct. 4, 2010.

(51) Int. Cl. B32B 3/00

(52) U.S. Cl. 428/195.1; 428/474.4

(57) ABSTRACT

A Thermal Poly Rubber (TPR) toy which is produced from a TPR base toy over which one or more diecut polymer and/or TPR layers are provided so as to produce a TPR toy having a more vibrant appearance, and a textured feel and appearance. The TPR toy reduces or eliminates the need for subsequent printing on the surface of the TPR toy.

### FIELD OF THE INVENTION

This invention relates generally to toys, and more particularly, to toys produced from thermal poly rubber, in which a series of one or more pre-cut, coloured TPR layers are built up on the exterior of a TPR-toy base layer.

### BACKGROUND OF THE INVENTION

Thermal Poly Rubber (TPR) is commonly used in the production of toys due to its extremely soft and flexible nature. Examples of typical toy products include stress relief balls, which are commonly filled with a liquid, and which undergo tremendous stretching, when squeezed. Additionally, because of its soft, and slightly tacky feel, TPR can be used in products such as the toy described in US Patent Publication No. 2005/0009442.

A problem which results from the use of this material, however, is that it is difficult to provide any printing on the toys, which will withstand the stretching and flexing of the toy. As such, while the TPR material may be coloured to provide any selected colour, any printing that is subsequently applied will typically quickly fail and fall off as the toy is stretched or flexed.

Further, even holding the extremely soft, flexible and tacky material in a position to allow printing, can also be challenging.

At present therefore, current TPR toy decoration methods typically involve using a pad print operation. However, the inks used do not bond well to the TPR rubber, and quickly wear off over time due to the stretching and flexing of the toy.

As an alternative to printing on the outside of the TPR toy, there is also the option of providing print material on the inside of the TPR toy shell prior to toy production. Another approach is to apply a clear cover over a pre-printed TPR toy in order to minimize or eliminate flaking or wear of the printed image. However, these approaches typically result in a muted appearance, with poor image quality.

As such, it would be beneficial to provide a method for producing a TPR toy in which printing, or other graphical displays, were more vibrant.

### SUMMARY OF THE INVENTION

An exemplary implementation of the method the present invention is the use of a one or more layers of pre-cut polymer layers, and preferable pre-cut TPR layers, which are applied over a base TPR toy structure. The polymer and/or TPR layers are preferably diecut to a selected shape or pattern, and are also preferably coloured a different colour than the base toy so that a pattern or design on the toy, becomes evident.

As such, in a first aspect, the present invention provides a Thermal Poly Rubber (TPR) layered toy comprising a base TPR toy, which base toy is at least partially covered by one or more layers of a pre-cut polymer layer.

The polymer material selected for the pre-cut polymer layer, can be any suitable material including nylon, or even fabric materials, and the colour of the polymer or TPR layer can be identical to the TPR base toy, if only a different feel or texture is desired.

The diecut TPR layers can also be made of the same, or a similar TPR material, as the outer layer of the base TPR toy, and thereby provide the same stretchy nature. As such, the resultant product is not only more durable, it has a unique textured appearance for toys in this category. Moreover, since the TPR layers are pre-coloured, the overall appearance of the toy is more vibrant that when using prior art printing techniques.

While any number of polymer and/or TPR layers can be used, typically, one to 3 layers of TPR are layered over the base TPR toy, and the layers are attached to the TPR toy (or previous TPR layer) using conventional techniques. These include glueing, sonic or heat welding, partial dissolution of the TPR material using a solvent, or the like. Alternatively, the TPR layers can be friction fit over the base TPR toy, and thus held in place by friction with the TPR base toy.

The polymer or TPR layers can be of any suitable thickness, or rigidity or material in order to create, for example, a defined texture, and/or to create a bulging effect around the more “squishy” inner layer of the base toy, particularly if the TPR base toy is a liquid filled toy, of the type known in the industry.

In a further aspect, the present invention also provides a TPR toy product comprising a base TPR toy, and one or a plurality of preferably different coloured TPR layers attached to the TPR base layer.

Preferably, the TPR base toy is a liquid filled toy having an outer TPR shell, over which the polymer layers can be applied. Production of the liquid filled TPR toys is known in the industry, and is outside of the scope of this invention.

### BRIEF DESCRIPTION OF THE DRAWINGS

Embodiments of this invention will now be described by way of example only in association with the accompanying drawings in which:

FIG. 1 is a drawing which represents a TPR base toy;

FIG. 2 is a drawing of a TPR diecut layer which is to be added to the exterior of the TPR base toy; and

FIG. 3 is a drawing of the final TPR layered, TPR toy of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

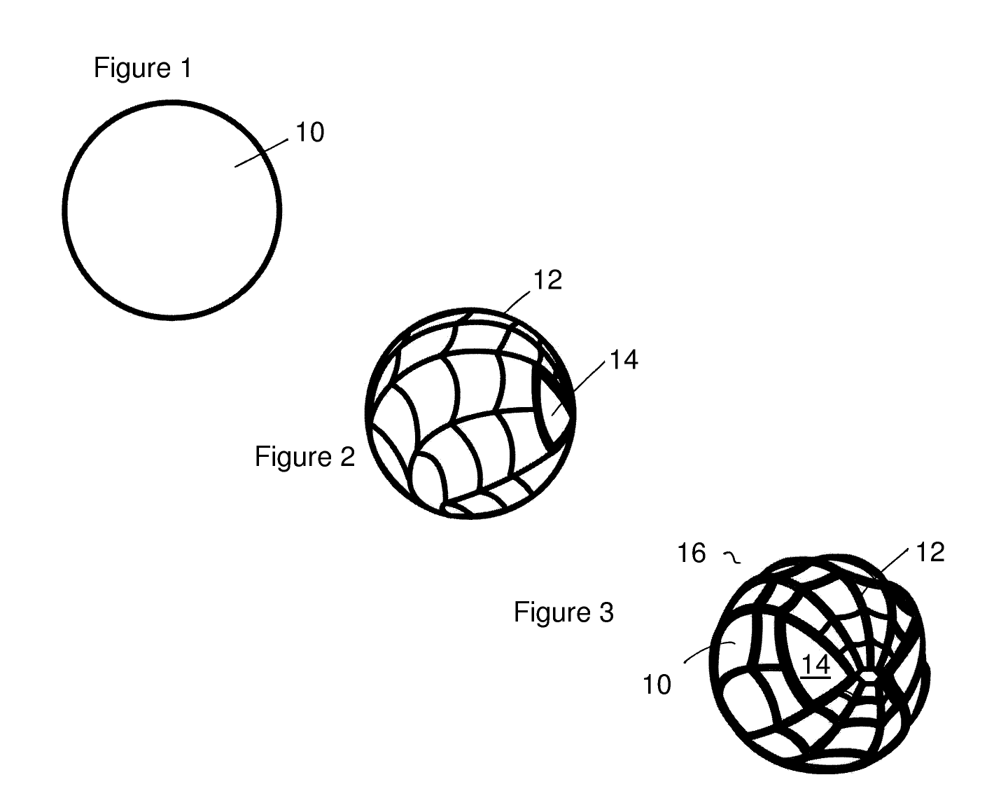

Referring to FIG. 1, a TPR base toy 10 is shown. Toy 10 is a liquid filled toy having a TPR outer layer. The liquid selected, and the manufacturing technique used to prepare the TPR base toy 10 are known in the industry, and are outside of the scope of this invention.

TPR Base toy 10 can be any suitable colour, such as, for example, a bright red colour.

In FIG. 2, a TPR diecut layer 12 is shown in the shape of a spider's web design, and is made of a black TPR material, with the exception of “eyes” 14, which are molded into diecut layer 12, using a white TPR material.

In FIG. 3, TPR layer 12 is fitted around base toy 10, so as to create a generally spherical shape for the finished toy 16, while also having a textured feel and appearance as a result of diecut layer 12 over base toy 10. TPR layer 12 is held in place by a friction fit onto base toy 10. This includes the normally “tacky” feel of the TPR layers, which assists in holding layer 12 in place.

The finished toy 16, if required, be subjected to an additional printing process, although this is not typically necessary or desired.

Additional layers can be provided, if desired.

Thus, it is apparent that there has been provided, in accordance with the present invention, a TPR toy product which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Also, unless otherwise specifically noted, all of the features described herein may be combined with any of the above aspects, in any combination.

Finally, while this discussion has addressed prior art known to the inventor, it is not an admission that all art discussed is citable against the present application.

What is claimed is:

1. A Thermal Poly Rubber (TPR) layered toy comprising a base TPR toy, which base toy is at least partially covered by one or more layers of a pre-cut polymer layer.

2. A TPR layered toy as claimed in claim 1 wherein said pre-cut polymer layers, are pre-cut TPR layers which have been applied over said base TPR toy.

3. A TPR layered toy as claimed in claim 1 wherein said pre-cut polymer layer is diecut to a selected shape or pattern

4. A TPR layered toy as claimed in claim 1 wherein said pre-cut polymer layer is a different colour than the base toy so that a pattern or design on the toy, becomes evident.

5. A TPR layered toy as claimed in claim 1 wherein said toy has one to 3 layers of pre-cut TPR layered over said base TPR toy.

6. A TPR layered toy as claimed in claim 1 wherein said base TPR toy is a liquid filled toy having an outer TPR shell.
